(19) United States
(12) Patent Application Publication
(10) Pub. No.: US 2026/0224014 A1
(43) Pub. Date: Aug. 6, 2026

(54) TOOL HOLDER

(71) Applicant: CIRK-L AB, Svenljunga (SE)

(72) Inventors: Christian AHL, Malmö (SE); Kasimir HELLSTRÖM, Hurva (SE); Morten SAXBØL, Gadstrup (DK)

(73) Assignee: CIRK-L AB, Svenljunga (SE)

(21) Appl. No.: 19/155,094

(22) PCT Filed: Feb. 9, 2024
(86) PCT No.: PCT/EP2024/053382

§ 371 Date: Aug. 8, 2025

(30) Foreign Application Priority Data
Feb. 10, 2023 (EP) 23156061.6

(51) Int. Cl. A45F 5/02; A45F 5/00

(52) U.S. Cl. CPC A45F 5/021; A45F 5/1575

(57) ABSTRACT

A tool holder for holding a tool having a substantially flat belt hook, such as an electrical drill or screwdriver. The tool holder including a support member; a loop element attached to the support member, the loop member is made of a rigid material and forms a hook space between the loop member and the support member for accommodating the belt hook of the tool; a locking mechanism for maintaining the belt hook in a locked position in the hook space, the locking mechanism configurable in a locked configuration blocking the belt hook from exiting the hook space and an unlocked configuration wherein the belt hook can exit the hook space, a spring mechanism causes the locking mechanism to be in the locked configuration when no external force by a user is applied.

### CROSS REFERENCE TO RELATED APPLICATIONS

The present application is the national phase entry of International Patent Application No. PCT/EP2024/053382 filed Feb. 9, 2024, which claims priority to European Patent Application No. 23156061.6 filed Feb. 20, 2023, the entire contents of both are hereby incorporated by reference.

### TECHNICAL FIELD

The present disclosure relates to a tool holder, more specifically a tool holder for holding a tool such an electrical drill/screwdriver with a metal hook. The tool holder may be attached or fastened to an item or garment, such as a pair of trousers.

### BACKGROUND

Craftsmen, such as carpenters and electricians, often use an electrical drill/screwdriver in their work and as the tool is commonly used there is a need for storing the drill close at hand.

It is common that electrical drills, and other electrical tools, are delivered with a metal hook on the handle that can be used to hang the tool on suitable places. A frequent solution is that tradesmen hang the drill on the edge of a side or back pocket, or on the belt, on the work trousers. This is not an optimal solution as it both wears out the workwear trouser and the drill is not safely stored. The tool can easily fall off.

Other tool holders specifically developed to store an electrical drill exist. These tool holders can be integrated in a tool belt, alternatively the tool holder can be attached to a tool belt or workwear. These tool holders usually have the purpose of storing the tool when it is not in use and can be designed in different ways having various sizes, shapes, and materials.

Drill holders are provided in a range of configurations and sizes. The two most common versions are, firstly, a metal loop attached on a tool belt, tool pouch, or specific tool holder where the metal hook that is mounted on the drill can be placed, and secondly, a drill holster that is attached to a workwear garment or a tool belt where the drill can be placed.

The disadvantage with the metal hook is that the drill is not safely stored. If the tool is pushed upwards, it will fall off.

The drill holsters experience the same issue, but usually solves the problem by adding some kind of safety strap that the user put around the drill and locks it into place. However, the safety strap must be actively put on the drill. In practice this is not always done.

Consequently, there are a number of disadvantages with the existing tool holders developed to store an electrical drill. It would therefore be useful to have a tool holder that is convenient to use but also possible to lock.

### SUMMARY

The present disclosure relates to a tool holder for holding a tool having a substantially flat belt hook, such as an electrical drill or screwdriver, the tool holder comprising:
a support member;
a loop element attached to the support member, wherein the loop member is made of a rigid material and forms a hook space between the loop member and the support member for accommodating the belt hook of the tool; and
a locking mechanism for maintaining the belt hook in a locked position in the hook space, the locking mechanism configurable in a locked configuration blocking the belt hook from exiting the hook space and an unlocked configuration wherein the belt hook can exit the hook space, wherein a spring mechanism causes the locking mechanism to be in the locked configuration when no external force by a user is applied. In embodiments, the tool holder is configured such that the user needs to perform a manual actuation to unlock the tool holder in order to avoid that the tool holder is accidentally unlocked.

The tool may typically be an electrical drill or screwdriver, but can also be any tool with a belt hook or clip. Consequently, the disclosed tool holder can be used not only by craftsmen but, for example, gardeners, cleaning staff, police officers, fire fighters, military staff, etc. The belt hook typically has two substantially flat parallel parts connected to form a U-shape. FIGS. 4A and B show an example of a belt hook 104, which has a tool-facing element 112, which may be attached to the tool, and a hook element 111, which is conventionally either placed directly around a belt, or inserted into a recess adapted to receive the hook element. At least the hook element is typically substantially flat. The tool-facing element does not necessarily have to be substantially flat. The belt hook of the type shown in FIGS. 4A-4B is frequently used on, for example, electrical screwdrivers. As can be seen in FIG. 4A, the hook element 111 does not have to be a sheet without holes or cut-outs. In the examples FIGS. 4A-4B, the hook element 111 itself is also a U-shaped sheet. The hook element may be a sheet, in embodiments made of metal, which has an outer contour shaped substantially as a rectangle, or having an outer contour slightly tapered towards a distal end, i.e. the end the is first inserted into the hook space. A person skilled in the art will understand that variations of the hook element may be possible.

The presently disclosed tool holder comprises a locking mechanism for maintaining the belt hook in a position in which it can securely be worn by a user. The locking mechanism may comprise one or more hinged doors, or one or more blocking plates, such as one or more spring-loaded pivotable plates and/or one or more blocking plates made of a flexible material that can be opened at least inwards, i.e. towards the support member, or downwards, i.e. towards the loop element, from the locked configuration by pushing the hook element of the belt hook into the hook space of the tool holder. The one or more hinged doors or blocking plates may be spring-loaded. The locking mechanism may thereby be considered to be locked in the sense that the one or more hinged doors or blocking plates cannot be opened outwards or upwards without actively unlocking the locking mechanism. In order to unlock the locking mechanism, such that the one or more hinged doors or blocking plates can be opened outwards or upwards, the user has to unlock the locking mechanism actively, typically be pushing the tool, which is attached to the belt hook towards the tool holder. Further movements to unlock the tool can also be implemented. For example, the locking mechanism can be implemented such that a pulling movement (i.e. away from the support member), a sideways movement, a turning or tilting movement, a movement upwards or downwards, or a combination, is required to unlock the locking mechanism. This embodiment, which allows the user to grab a tool in the holder, in a first step push it towards the tool holder (i.e. typically towards the body of the user) and in a second step lift the tool upwards out of the hook space, present a convenient solution for the user, which can, in two simple unlock and release gestures, release the tool from the tool holder using only one hand. The locking mechanism may comprise a spring-loaded mechanism that automatically closes the one or more hinged doors or blocking plates to the locked configuration when the user does not actively open the one or more hinged doors or blocking plates by inserting the belt hook or by manually unlocking the tool holder.

The present disclosure further relates to a method for inserting a belt hook in a tool holder, comprising:
providing a tool holder comprising:
   a support member;
   a loop element attached to the support member, wherein the loop member is made of a rigid material and forms a hook space between the loop member and the support member for accommodating the belt hook of the tool; and
   a locking mechanism for maintaining the belt hook in a locked position in the hook space, the locking mechanism configurable in a locked configuration blocking the belt hook from exiting the hook space and an unlocked configuration wherein the belt hook can exit the hook space, wherein a spring mechanism causes the locking mechanism to be in the locked configuration when no external force by a user is applied;
from the locked configuration, inserting the belt hook into the tool holder by pushing one or more hinged doors inwards and/or downwards and/or sideways in one gesture.

The tool holder allows the user to push the belt hook into the hook space using a simple gesture. When the belt hook has been pushed into the hook space the tool holder automatically goes back to the locked configuration in which the belt hook cannot accidently exit the hook space.

The present disclosure further relates to a method for releasing a belt hook from a tool holder, comprising:
providing a tool holder comprising:
   a support member;
   a loop element attached to the support member, wherein the loop member is made of a rigid material and forms a hook space between the loop member and the support member for accommodating the belt hook of the tool; and
   a locking mechanism for maintaining the belt hook in a locked position in the hook space, the locking mechanism configurable in a locked configuration blocking the belt hook from exiting the hook space and an unlocked configuration wherein the belt hook can exit the hook space, wherein a spring mechanism causes the locking mechanism to be in the locked configuration when no external force by a user is applied;
from the locked configuration, releasing the belt hook from the tool holder by pushing the belt hook from a position in the hook space towards the support member, and/or pulling the belt hook from the support member, and/or moving the belt hook sideways, and/or turning and/or tilting the belt hook, to unlock the tool holder and subsequently moving the belt hook out of the hook space.

The user may release the belt hook from the tool holder using one hand. The release gesture may typically comprise a pushing movement and a subsequent upwards movement of the belt hook. One advantage of this sequence, besides being easy to do for the user, is that typically does not happen by accident.

These and other aspects of the present disclosure are set forth in the following detailed description.

### DESCRIPTION OF THE DRAWINGS

Specific embodiments of the presently disclosed tool holder are shown in the drawings. The drawings are examples of embodiments and are intended to illustrate some of the features of the presently disclosed tool holder, and are not to be construed as limiting to the presently disclosed present disclosure.

FIG. 1A shows a top view of an embodiment of the presently disclosed tool holder, including a belt hook securely placed in the tool holder.

FIG. 1B shows a front view of the embodiment of the presently disclosed tool holder, including the belt hook securely placed in the tool holder.

FIG. 1C shows a side view of the embodiment of the presently disclosed tool holder, including the belt hook securely placed in the tool holder.

FIG. 2A shows a top view of a further embodiment of the presently disclosed tool holder, including a belt hook securely placed in the tool holder.

FIG. 2B shows a front view of the further embodiment of the presently disclosed tool holder, including the belt hook securely placed in the tool holder.

FIG. 2C shows a side view of the further embodiment of the presently disclosed tool holder, including the belt hook securely placed in the tool holder.

FIG. 3A shows a top view of a further embodiment of the presently disclosed tool holder, including a belt hook securely placed in the tool holder.

FIG. 3B shows a front view of the further embodiment of the presently disclosed tool holder, including the belt hook securely placed in the tool holder.

FIG. 3C shows a side view of the further embodiment of the presently disclosed tool holder, including a belt hook securely placed in the tool holder.

FIG. 4A shows a perspective view of an example of a belt hook.

FIG. 4B shows a side view of the example of the belt hook.

FIG. 5A shows an example of a step in a sequence of steps for inserting a belt hook into the tool holder.

FIG. 5B shows an example of another step in the sequence of steps for inserting the belt hook into the tool holder.

FIG. 5C shows an example of another step in the sequence of steps for inserting the belt hook into the tool holder.

FIG. 5D shows an example of another step in the sequence of steps for inserting the belt hook into the tool holder.

FIG. 6A shows an example of a step in a sequence for removing a belt hook from the tool holder.

FIG. 6B shows an example of another step in the sequence of steps for removing the belt hook from the tool holder.

FIG. 6C shows an example of another step in the sequence of steps for removing the belt hook from the tool holder.

FIG. 6D shows an example of another step in the sequence of steps for removing the belt hook from the tool holder.

FIG. 7A shows a further example of a step in a sequence of steps for inserting a belt hook into the tool holder.

FIG. 7B shows a further example of another step in the sequence of steps for inserting the belt hook into the tool holder.

FIG. 7C shows a further example of another step in the sequence of steps for inserting the belt hook into the tool holder.

FIG. 8A shows a further example of a step in a sequence of steps for removing a belt hook from the tool holder.

FIG. 8B shows a further example of another step in the sequence of steps for removing the belt hook from the tool holder

FIG. 8C shows a further example of another step in the sequence of steps for removing the belt hook from the tool holder

FIG. 9A shows a further example of a step in a sequence of steps for inserting a belt hook from the tool holder.

FIG. 9B shows a further example of another step in the sequence of steps for inserting the belt hook from the tool holder.

FIG. 9C shows a further example of another step in the sequence of steps for inserting the belt hook from the tool holder.

FIG. 10A shows a further example of a step in a sequence of steps for removing a belt hook from the tool holder.

FIG. 10B shows a further example of another step in the sequence of steps for removing the belt hook from the tool holder.

FIG. 10C shows a further example of another step in the sequence of steps for removing the belt hook from the tool holder.

### DETAILED DESCRIPTION

The present disclosure relates to a tool holder for holding a tool having a substantially flat belt hook, such as an electrical drill or screwdriver. In embodiments, the tool holder comprises a support member. A loop element may be attached, directly or indirectly, to the support member. The loop member may typically be a rigid structure, made of for example metal or a stiff plastic material, and forms a hook space between the loop member and the support member for accommodating the belt hook of the tool. The hock space is typically a relatively narrow space into which the hook element of the belt hook can be inserted. Generally, it is beneficial if the hook element fits in the hook space such in a stable configuration. The tool holder further comprises a locking mechanism for maintaining the belt hook in a locked position in the hook space, wherein the locking mechanism is configurable in a locked configuration blocking the belt hook from exiting the hook space and in an unlocked configuration wherein the belt hook can exit the hook space. In embodiments, the locking mechanism comprises a spring mechanism which causes the locking mechanism to be in the locked configuration when no external force by a user is applied.

The tool holder can be integrated in a tool belt or workwear, alternatively be a separate item that can be attached to a tool belt or workwear with the help of an attachment. The tool holder can furthermore be attached to more places where the user would like to store the tool holder and/or the tool. Such places could be on a tool board, a work car, a toolbox, a tool cart, a tool bag, tool pouch and similar places. It can also be directly on a garment.

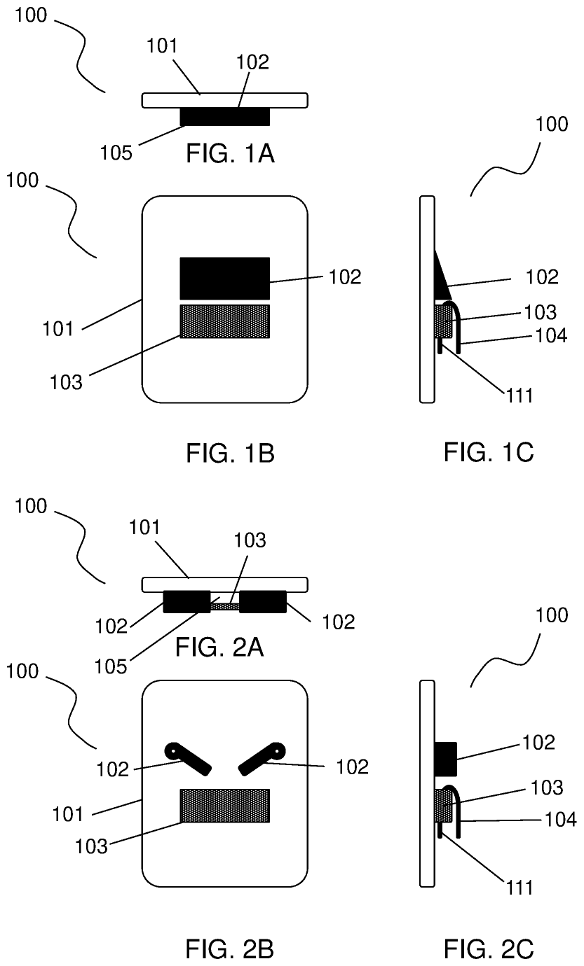

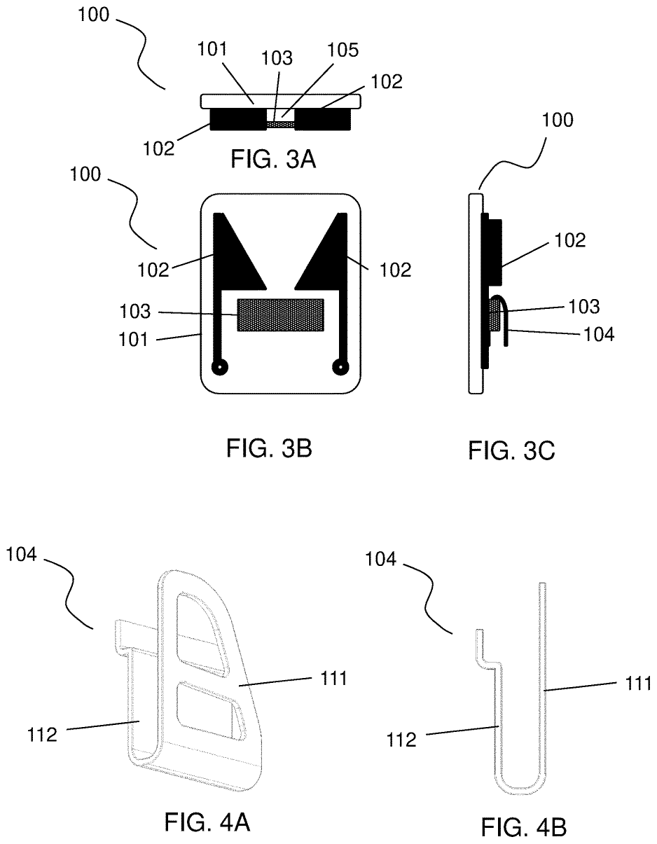

FIGS. 1A-3C show three different embodiments of the presently disclosed tool holder 100. In each embodiment the tool holder 100 has a support member 101, a loop member 103, and a locking mechanism 102 comprising one or more hinged doors 102. As can be seen in, for example, FIG. 1C, the tool holder makes use of the U-shape of the belt hook 104. The hook element 111 of the belt hook 104 is in the hook space 105 in the locked configuration. The hinged door 102 blocks the belt hook 104 from leaving the hook space 105. There is a gap between the hinged door 102 and the loop member 103 in the locked configuration. The bottom of the ‘U’ of the U-shaped belt hook 104 is located in the gap when the hook element 111 of the belt hook 104 is in the hook space 105 in the locked configuration. A general concept shared by three embodiments is that the user shall be able to push the belt hook into a position in the hook space of the tool holder even if the tool holder is in the locked configuration. This can typically be achieved by a mechanism allowing the one or more hinged doors to open in one direction but not the opposite direction in the locked configuration. In order to move the belt hook out of the hook space of the tool holder the user will typically have to make use of a manual actuation mechanism, which will allow to open the one or more hinged doors in the opposite direction, or actively open the one or more hinged doors in the first direction.

The locking mechanism may comprise one or more hinged doors, or one or more blocking plates, in embodiments one or more spring-loaded blocking plates and/or one or more blocking plates made of a flexible material, that can be opened at least inwards, i.e. towards the support member, or downwards, i.e. towards the loop element, from the locked configuration by pushing the hook element of the belt hook into the hook space of the tool holder. The hinged door may be hinged at a pivot point. A similar solution can be implemented as a blocking, optionally, pivotable plate. The blocking plate does not necessarily need a hinge. The blocking plate may be made of a flexible material. More specifically, it may be configured such that, upon application of a force by the tool, the blocking plate can be bent inwards/downwards when a force is applied to it, and then return to its original shape upon cessation of the applied force. In the following description, when reference is made to a hinged door, a person skilled in the art will realize that certain features may be used equivalently for the blocking plate. The blocking plate can be made of spring steel. In the following description, when reference is made to a hinged door, a person skilled in the art will realize that certain features may be used equivalently for the blocking plate.

As stated the locking mechanism may comprise a spring-loaded hinged door. As would be realized by a person skilled in the art, the spring may be implemented in several ways, including, for example a coil spring, leaf spring or torsion spring. Generally, a spring should be integrated or added to the hinged door in a way that the hinged door returns to the locked configuration automatically when no external force is applied by a user. In a typical scenario the user places the belt hook in the tool holder by pushing it into the hook space. When the belt hook has entered the tool holder the spring forces the hinged door to automatically return to the locked configuration.

The locking mechanism may further comprise a plate attached to the support member. The plate may have a bottom hinge around which the plate can be pivoted when the plate is pushed towards the support member. The plate may be connected to the hinged door at a connection point. Pivoting the plate may thereby also cause the hinged door to pivot. This can be used to open the locking mechanism.

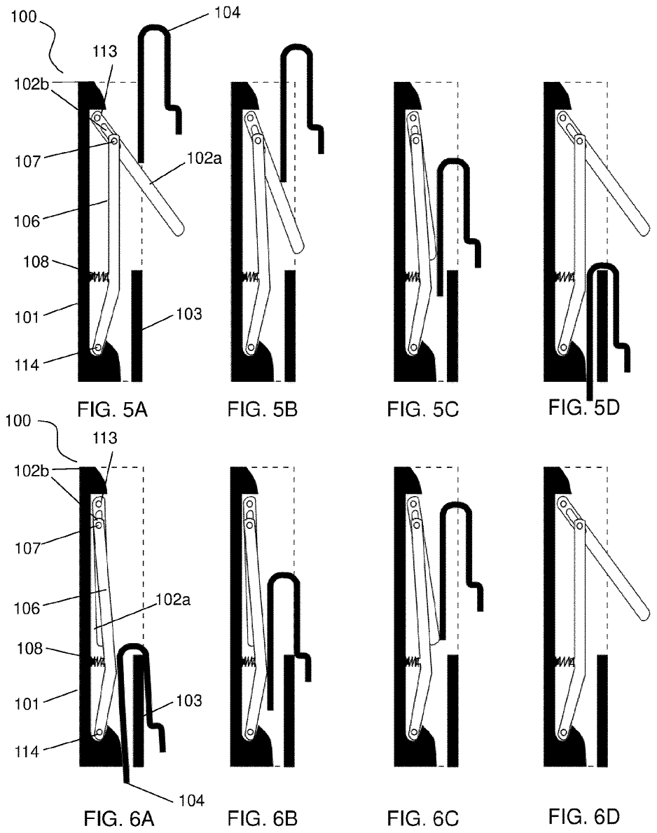

FIGS. 5A-5D show an embodiment of the presently disclosed tool holder 100 and an example of a sequence of steps for inserting a belt hook 104 into the tool holder 100. In this embodiment the hinged door 102 can be opened inwards by pushing a distal part 102a of the hinged door, oriented towards the loop element 103, towards the support member 101. In FIG. 5A the hinged door 102 is in a closed and locked configuration. Any of the plate 106 and the hinged door 102 can be spring-loaded. In the embodiment of FIGS. 5A-5D the spring 108 has been placed between the plate 106 and the support member 101. The spring can also be placed, for example at the end of the hinged door 102, which may be attached to a pivot point 113. Alternatively, it can be done at the bottom hinge 114 of the plate 106. The spring may be, for example, a leaf spring or a torsion spring having one end connected to the hinged door 102 or plate 106 and one end connected to a fixed part such as the support member 101. The locking mechanism may further comprise a plate 106 attached to the support member 101 and to the locking mechanism, wherein a top end of the plate 106 is connected to the hinged door 102 at a connection point 107 In FIG. 5B the belt hook 104 starts pushing the hinged door 102 inwards, towards the support member 101. In FIG. 5C the hinged door 102 has been opened and the belt hook 104 starts moving downwards into the hook space 105. In FIG. 5D the belt hook 104 is located in the hook space 105 of the tool holder 100. The hinged door 102 automatically returns to the locked configuration.

FIGS. 6A-6D show an example of a sequence of steps for removing the belt hook 104 from the tool holder 100. In FIG. 6A the belt hook 104 is located in the hook space 105 of the tool holder 100. From this configuration the tool holder 100 can be opened by pushing the the plate 106 towards the support member 101 such that the distal part 102a of the hinged door 102 does not block the belt hook 104 from being removed from the tool holder 100, as shown in FIG. 6A. In FIGS. 6B and 6C the belt hook 104 is removed from the tool holder 100. In FIG. 6D the hinged door 102 has returned to the locked configuration. It can be noted that the plate 106 has a bottom hinge 114, around which the plate is slightly pivoted when the plate 106 is pushed towards the support member 101. The plate 106, which is connected to the hinged door 102 at a connection point 107, thereby also pushes the rod 107 of the hinged door 102 towards the support member 101, which causes the hinged door 102 to pivot inwards to the unlocked configuration. In principle it is possible to adapt the tool holder 100 such that pushing a certain area of the plate 106 causes the tool holder 100 to unlock. In practice, a convenient solution is to design the tool holder 100 such that the user unlocks the tool holder 100 by grabbing a tool, to which the belt hook 104 is attached, and pushing the tool and the belt hook 104 towards the support member 101. In this way the user can grab the tool and release the belt hook 104, to which the tool is attached, from the tool holder 100 using only one hand. It can also be noted that in the arrangement of FIGS. 5 and 6, wherein the plate 106 engages with the rod 107 of the hinged door 107 at the connection point 107, a relatively small movement of the plate 106 will result in a greater movement of the distal end of the hinged door 102.

In order to unlock the locking mechanism, such that the one or more hinged doors can be opened outwards or upwards, the user has to unlock the locking mechanism actively, typically be pushing the tool, which is attached to the belt hook towards the tool holder. Further movements to unlock the tool can also be implemented. For example, the locking mechanism can be implemented such that a pulling movement (i.e. away from the support member), a sideways movement, a turning or tilting movement, a movement upwards or downwards, or a combination, is required to unlock the locking mechanism. In one embodiment the tool holder is further configured such that unlocking the tool holder requires an additional gesture to unlock the tool holder. This may be achieved by requiring turning of the belt hook or sliding the belt hook sideways before pushing the belt hook towards the support member. This mechanism can be achieved by, for example a further pin, plate or other element that blocks pushing until the turning or sliding movement has been completed. The loop element may also be part of such an embodiment. For example, the loop element may be attached to the support member through one or more unlocking spring elements and/or other elements. The one or more unlocking spring elements can be arranged such that the loop element can be pushed downwards and/or towards the support member to unlock the locking mechanism. In one embodiment, in order to unlock the locking mechanism, it is required that the user first moves the loop element downwards. This enables the possibility of further pushing the loop element towards the support member to unlock the locking mechanism. From there the user can move the loop element upwards to release it from the tool holder. The continuous gesture can be illustrated as a “U”.

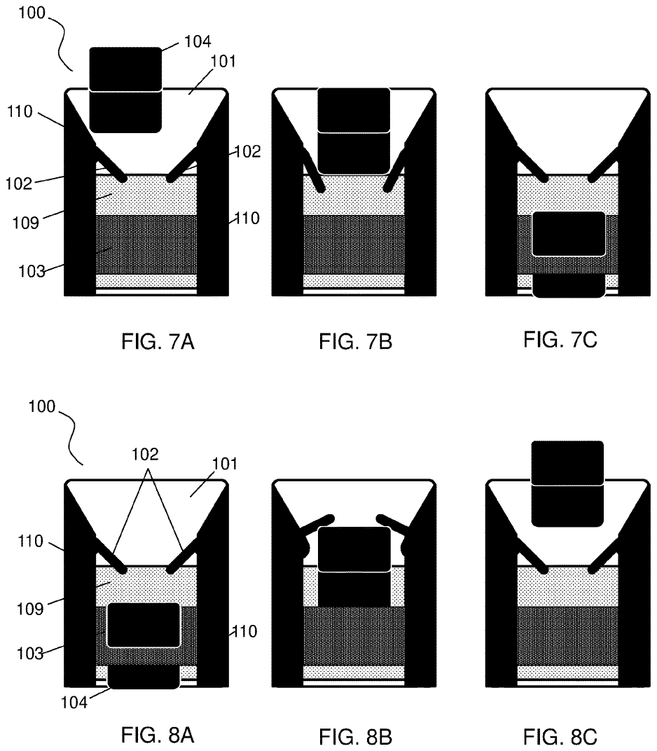

The locking mechanism may, alternatively, comprise two spring-loaded hinged doors that hinged can be opened downwards. In such an embodiment the two spring-loaded hinged doors may have pivot points at the sides of a passage, in embodiments a vertical passage, for the belt hook into the hook space. The tool holder may further comprise a push button, wherein pushing the push button allows the two spring-loaded hinged doors to open upwards, allowing the belt hook to exit the hook space. FIGS. 7A-7C and 8A-8C show example of an embodiment having two spring-loaded hinged doors that hinged can be opened downwards. Such an embodiment may have elevated sides. The elevated sides may hide the pivot points of the two spring-loaded hinged doors. The tool holder may be dimensioned such that the two spring-loaded hinged doors fit under the elevated sides in an open configuration. The tool holder has an inwardly tapered top part for guiding the belt hook into the hook space. More specifically, the elevated sides may be inwardly tapered.

FIG. 7A-7C show a further embodiment of the presently disclosed tool holder 100 and an example of a sequence of steps for inserting a belt hook 104 into the tool holder 100. In this embodiment the hinged doors 102 can be opened downwards. In FIG. 7A the hinged doors 102 are in a closed and locked configuration. The hinged doors 102 are spring-loaded. The springs may be, for example, leaf springs or torsion springs having one end connected to the hinged door and one end connected to a fixed part. In FIG. 7B the belt hook 104 starts pushing the hinged doors 102 downwards. In FIG. 7C the belt hook 104 is located in the hook space 105 of the tool holder 100. The spring-loaded hinged doors 102 automatically return to the locked configuration.

FIGS. 8A-8C show an example of a sequence of steps for removing the belt hook 104 from the tool holder 100. In FIG. 8A the belt hook 104 is located in the hook space 105 of the tool holder 100. From this configuration the tool holder 100 can be unlocked by pushing the the button 109 towards the support member 101 as shown in FIG. 8B. The belt hook 104 starts moving upwards. The spring-loaded hinged doors 102 can be moved upwards in this configuration. In FIG. 8C the belt hook 104 has been removed from the tool holder 100 and the spring-loaded hinged doors 102 automatically return to the locked configuration.

The locking mechanism may, alternatively, or additionally, comprise two spring-loaded hinged doors that hinged can be opened to the sides. In one embodiment the tool holder comprises a push button, wherein pushing the push button moves the two spring-loaded hinged doors to the sides, allowing the belt hook to exit the hook space.

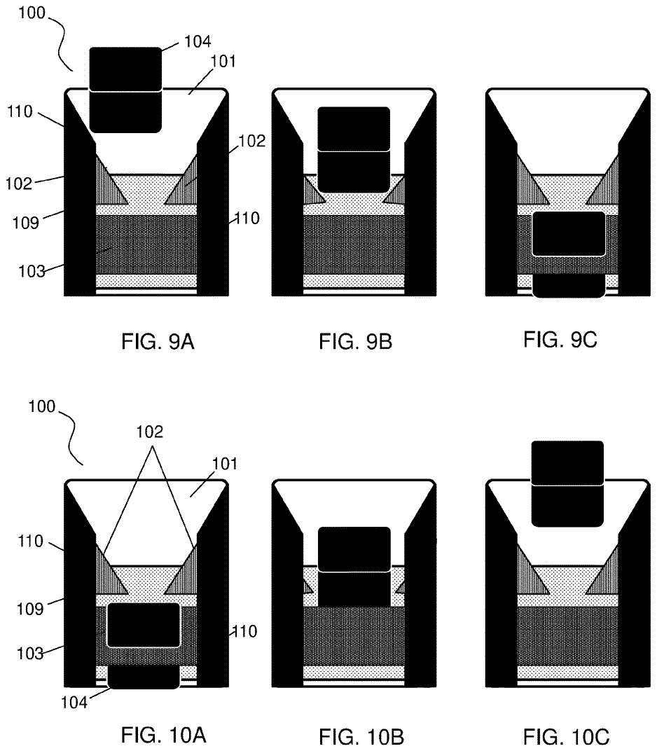

FIGS. 9A-9C show a further embodiment of the presently disclosed tool holder 100 and an example of a sequence of steps for inserting a belt hook 104 into the tool holder 100. In this embodiment the hinged doors 102 can be opened outwards. In FIG. 9A the hinged doors 102 are in a closed and locked configuration. The hinged doors 102 are spring-loaded. The springs may be, for example, leaf springs or torsion springs having one end connected to the hinged door and one end connected to a fixed part. In FIG. 9B the belt hook 104, which moves downwards, starts pushing the hinged doors 102 to the sides. In FIG. 9C the belt hook 104 is located in the hook space 105 of the tool holder 100. The spring-loaded hinged doors 102 automatically return to the locked configuration.

FIG. 10A-10C show an example of a sequence of steps for removing the belt hook 104 from the tool holder 100. In FIG. 10A the belt hook 104 is located in the hook space 105 of the tool holder 100. From this configuration the tool holder 100 can be unlocked and the hinged doors 102 pushed to the sides by pushing the belt hook 104 towards the support member 101 as shown in FIG. 10B. The belt hook 104 is then pulled upwards. In FIG. 10C the belt hook 104 has been removed from the tool holder 100 and the spring-loaded hinged doors 102 automatically return to the locked configuration.

Generally, a number of parameters can be adjusted to strike a balance between security and ease of use. As an example, as stated, the tool holder may be adapted such that only a certain area of the plate will unlock the tool holder, when pushed. Designing the tool holder such that the area is larger will make it easier to accidently unlock the tool holder. Similarly, the spring can be dimensioned to find a suitable level of required external force for unlocking the tool holder. A stiffer spring will require a greater force by the user.

### LIST OF ELEMENTS IN FIGURES

100—tool holder
101—support member
102—locking mechanism, hinged door
103—loop element
104—belt hook
105—hook space
106—plate
107—connection point
108—spring
109—push button
110—elevated sides
111—hook element
112—tool-facing element
113—pivot point
114—plate bottom hinge

1. A tool holder for holding a tool having a belt hook, such as an electrical drill or screwdriver, the tool holder comprising:
a support member;
a loop element attached to the support member, wherein the loop member is made of a rigid material and forms a hook space between the loop member and the support member for accommodating the belt hook of the tool; and
a locking mechanism for maintaining the belt hook in a locked position in the hook space, the locking mechanism configurable in a locked configuration blocking the belt hook from exiting the hook space and an unlocked configuration wherein the belt hook can exit the hook space,
wherein a spring mechanism causes the locking mechanism to be in the locked configuration when no external force by a user is applied.

2. The tool holder according to claim 1, wherein the locking mechanism comprises a hinged door, preferably a spring-loaded hinged door, or a blocking plate, preferably a spring-loaded blocking plate and/or a blocking plate made of a flexible material.

3. The tool holder according to claim 2, wherein the hinged door or a blocking plate can be opened inwards by pushing a distal part of the hinged door or a blocking plate, oriented towards the loop element, towards the support member.

4. The tool holder according to claim 2, wherein the hinged door or a blocking plate is attached to a pivot point.

5. The tool holder according to claim 2, wherein the locking mechanism further comprises a plate attached to the support member, wherein a top end of the plate is connected to the hinged door or a blocking plate at a connection point.

6. The tool holder according to claim 1, wherein the wherein the locking mechanism comprises two spring-loaded hinged doors or blocking plates that can be opened downwards.

7. The tool holder according to claim 6, wherein the two spring-loaded hinged doors or blocking plates have pivot points at the sides of a passage for the belt hook into the hook space.

8. The tool holder according to claim 6 further comprising a push button, wherein pushing the push button allows the two spring-loaded hinged doors or blocking plates to open upwards, allowing the belt hook to exit the hook space.

9. The tool holder according to claim 1, wherein the locking mechanism comprises two spring-loaded hinged doors or blocking plates that can be opened to the sides.

10. The tool holder according to claim 9, wherein the two spring-loaded hinged doors or blocking plates have pivot points at the sides of a passage for the belt hook into the hook space.

11. The tool holder according to claim 9 further comprising a push button, wherein pushing the push button moves the two spring-loaded hinged doors or blocking plates to the sides, allowing the belt hook to exit the hook space.

12. The tool holder according to claim 1, wherein the tool holder has an inwardly tapered top part for guiding the belt hook into the hook space.

13. The tool holder according to claim 1, wherein the loop element is attached to the support member by one or more unlocking spring elements.

14. The tool holder according to claim 13, wherein the one or more unlocking spring elements are configured such that the loop element can be pushed downwards and/or towards the support member to unlock the locking mechanism.

15. A method for inserting a belt hook in a tool holder, comprising:
providing a tool holder comprising:
a support member;
a loop element attached to the support member, wherein the loop member is made of a rigid material and forms a hook space between the loop member and the support member for accommodating the belt hook of the tool; and
a locking mechanism for maintaining the belt hook in a locked position in the hook space, the locking mechanism configurable in a locked configuration blocking the belt hook from exiting the hook space and an unlocked configuration wherein the belt hook can exit the hook space, wherein a spring mechanism causes the locking mechanism to be in the locked configuration when no external force by a user is applied;
from the locked configuration, inserting the belt hook into the tool holder by pushing one or more hinged doors or blocking plates inwards and/or downwards and/or sideways in one gesture.

16. A method for releasing a belt hook from a tool holder, comprising:
providing a tool holder comprising:
a support member;
a loop element attached to the support member, wherein the loop member is made of a rigid material and forms a hook space between the loop member and the support member for accommodating the belt hook of the tool; and
a locking mechanism for maintaining the belt hook in a locked position in the hook space, the locking mechanism configurable in a locked configuration blocking the belt hook from exiting the hook space and an unlocked configuration wherein the belt hook can exit the hook space, wherein a spring mechanism causes the locking mechanism to be in the locked configuration when no external force by a user is applied;
from the locked configuration, releasing the belt hook from the tool holder by pushing the belt hook from a position in the hook space towards the support member and/or pulling the belt hook from the support member, and/or moving the belt hook sideways, and/or turning and/or tilting the belt hook, to unlock the tool holder and subsequently moving the belt hook out of the hook space.
